(19) United States
(12) Patent Application Publication
(10) Pub. No.: US 2005/0280849 A1
(43) Pub. Date: Dec. 22, 2005

(54) Correcting background color of a scanned image

(76) Inventors: Keiji Kojima, Kanagawa-ken (JP); Tadashi Araki, Kanagawa-ken (JP); Maki Shinoda, Tokyo-to (JP); Hiroyuki Ukida, Tokushima (JP)

Correspondence Address: DICKSTEIN SHAPIRO MORIN & OSHINSKY LLP, 2101 L Street, NW, Washington, DC, 20037, US

(21) Appl. No.: 11/143,730

(22) Filed: Jun. 3, 2005

(30) Foreign Application Priority Data
Jun. 3, 2004 (JP) 2004-165559

(51) Int. Cl. H04N 1/60

(52) U.S. Cl. 358/1.9; 358/518

(57) ABSTRACT

An apparatus, system, method, computer program and product, each capable of correcting background color of a scanned image. A scanned image having a distorted portion and an undistorted portion is obtained. A reference background color is calculated using information obtained from the entire scanned image. Using the reference background color, a background color of the scanned image is corrected.

### CROSS-REFERENCE TO RELATED APPLICATIONS

The present invention is based on and claims priority to Japanese patent application No. JPAP 2004-165559 filed on Jun. 3, 2004, in the Japanese Patent Office, the entire contents of which are hereby incorporated by reference.

### FIELD OF THE INVENTION

The following disclosure relates generally to correcting background color of a scanned image.

### DESCRIPTION OF THE RELATED ART

When a book document, such as a book or a booklet having a bound boundary or spine, is placed on an exposure glass of a scanner, the book boundary or spine often raises above the surface of the exposure glass. As a result, a scanned image, particularly a portion corresponding to the book boundary or spine, suffers from lower image quality. For example, the boundary portion may have a darker background color, or it may have a distorted or blurred image.

In light of the above, various methods have been applied to increase the lowered quality of the scanned image. For example, the background color of the scanned image may be corrected using a reference background color. The reference background color can be calculated from information obtained from a selected portion of the scanned image. However, if the selected portion includes noise information, the resultant reference background color may not be accurate. As a result, the background color of the scanned image may not be corrected in a suitable manner. Further, the quality of the scanned image may be degraded due to the improper background color correction.

### BRIEF SUMMARY OF THE INVENTION

Exemplary embodiments of the present invention provide an apparatus, system, method, computer program and product, each capable of correcting background color of a scanned image.

For example, a scanned image having a distorted portion and an undistorted portion is obtained. A reference background color is calculated using information obtained from the entire scanned image. Using the reference background color, the distorted background color of the scanned image is corrected.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram illustrating a cross sectional view of a scanner according to an exemplary embodiment of the present invention;

FIG. 2 is a diagram illustrating a perspective view of an upper portion of an image forming apparatus, with a book document placed thereon, according to an exemplary embodiment of the present invention;

FIG. 3 is a block diagram illustrating basic components of the scanner of FIG. 1 according to an exemplary embodiment of the present invention;

FIG. 4 is a block diagram illustrating basic components of an image processor shown in FIG. 3 according to an exemplary embodiment of the present invention;

FIG. 5 is a block diagram illustrating basic components of a main controller shown in FIG. 3 according to an exemplary embodiment of the present invention;

FIG. 6 is a flowchart illustrating an operation of correcting background color of a scanned image according to an exemplary embodiment of the present invention;

FIG. 7 is an exemplary scanned image generated by the scanner of FIG. 1 according to an exemplary embodiment of the present invention;

FIG. 8 is a histogram illustrating the distribution of brightness values corresponding to a portion of the scanned image of FIG. 7 according to an exemplary embodiment of the present invention;

FIG. 9A is a graph illustrating the relationship between brightness profiles and portions of the scanned image of FIG. 7 according to an exemplary embodiment of the present invention;

FIG. 9B is a histogram illustrating the distribution of brightness values corresponding to the entire scanned image of FIG. 7 according to an exemplary embodiment of the present invention;

FIG. 10 is a flowchart illustrating an operation of correcting background color of a scanned image according to an exemplary embodiment of the present invention;

FIG. 11 is a flowchart illustrating an operation of correcting background color of a scanned image according to an exemplary embodiment of the present invention;

FIG. 12 is an illustration of a divided scanned image, parallel to a sub-scanning direction, according to an exemplary embodiment of the present invention;

FIG. 13 is an illustration of a divided scanned image, parallel to a main scanning direction, according to an exemplary embodiment of the present invention;

FIG. 14 is an illustration of a scanned image divided in a main scanning direction and a sub-scanning direction according to an exemplary embodiment of the present invention;

FIG. 15 is a flowchart illustrating an exemplary operation of correcting background color of a scanned image according to an exemplary embodiment of the present invention; and

FIG. 16 is a block diagram illustrating basic components of an image processor shown in FIG. 3, according to an exemplary embodiment of the present invention.

### DETAILED DESCRIPTION OF THE INVENTION

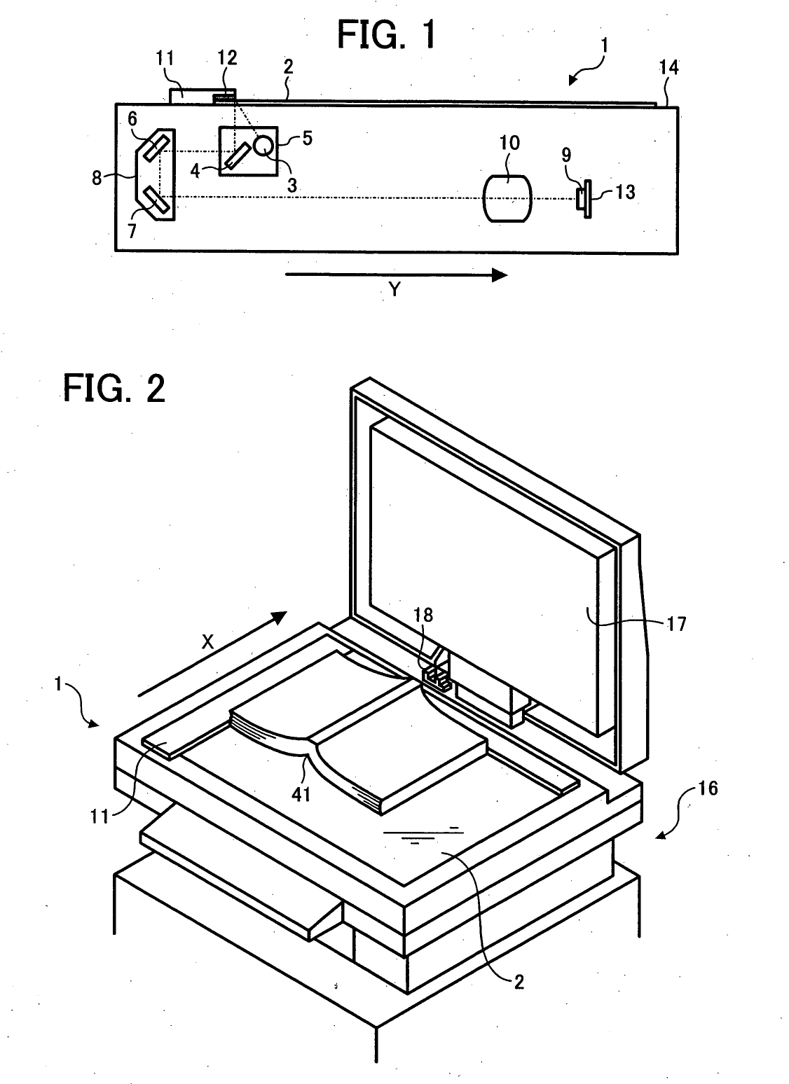

In describing the preferred embodiments illustrated in the drawings, specific terminology is employed for clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, FIG. 1 illustrates a scanner 1 according to an exemplary embodiment of the present invention.

The scanner 1 of FIG. 1 is capable of correcting the background color of a scanned image. As shown in FIG. 2, if a book document having a bound boundary 41 is scanned by the scanner 1, a portion corresponding to the bound boundary 41 may be shaded or darkened. The scanner 1 may correct the background color of the scanned image, particularly the portion corresponding to the bound boundary 41, using a reference background color calculated from the entire scanned image.

In addition to the background color correction, the scanner 1 of FIG. 1 may correct distortion of a scanned image. Referring back to FIG. 2, if the book document having the bound boundary 41 is scanned by the scanner 1, the portion corresponding to the bound boundary 41 may be distorted. The scanner 1 may correct the distortion of the portion corresponding to the bound boundary 41, using any one of a page outline, a rule line, or a character line, which may be extracted from the scanned image. Exemplary operations of correcting image distortion using any one of a page outline, a rule line, and a character line are described, for example, in U.S. patent application Ser. No. 10/227,743, filed on Aug. 26, 2003, U.S. patent application Ser. No.11/054,396, filed on Feb. 10, 2005, and U.S. Patent Application Publication No. 2003/0198398, published on Oct. 23, 2003, the entire contents of which are hereby incorporated by reference.

Alternatively, the scanner 1 of FIG. 1 may correct blurring of a scanned image in addition to the background color correction. Referring back to FIG. 2, if the book document having the bound boundary 41 is scanned by the scanner 1, the portion corresponding to the bound boundary 41 may have a blurred image. The scanner 1 may correct the blurring of the portion corresponding to the bound boundary 41, using any one of a page outline, a rule line, and a character line, which may be extracted from the scanned image.

As shown in FIG. 1, the scanner 1 includes an exposure glass 2, a first scanning body 5 having an exposing lamp 3 and a first reflection mirror 4, a second scanning body 8 having a second reflection mirror 6 and a third reflection mirror 7, a CCD (charged coupled device) 9, a lens 10, an original scale 11, a sensor board 13, and a frame 14.

To scan an original placed on the exposure glass 2, the first scanning body 5 and the second scanning body 8 move under the exposure glass 2, and direct a light emitted from the exposing lamp 3 to the original. The light reflected off the original is further reflected by the first reflection mirror 4, the second reflection mirror 6, and the third reflection mirror 7, toward the lens 10. The lens 10 forms an image on the CCD 9 according to the reflected light. The CCD 9 converts the formed image to image data.

The scanner 1 may be provided with a printer (not shown) to together function as an image forming apparatus, such as a digital copier 16 illustrated in FIG. 2. A press cover 17 opens or closes over the exposure glass 2. An open/close sensor 18 detects the opening or closing position of the press cover 17. The printer of the digital copier 16 may form a toner image on a recording sheet based on the image data generated by the scanner 1.

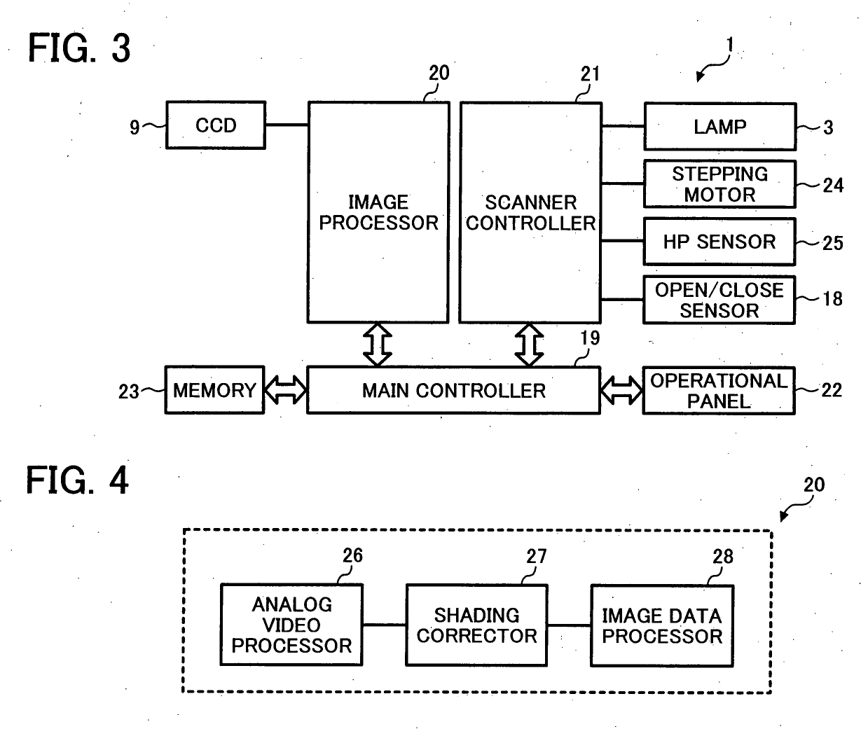

FIG. 3 is a block diagram illustrating the basic components of the scanner 1. A main controller 19 controls the entire operation of the scanner 1. The main controller 19 is connected to an image processor 20, a scanner controller 21, an operational panel 22, and a memory 23. The image processor 20 applies image processing to the image data generated by the CCD 9. The scanner controller 21 controls the first scanning body 5 and the second scanning body 8. The operational panel 22 displays various data including a message from the digital copier 16, or allows a user to input an instruction to the digital copier 16. The memory 23 stores various data, including image data received from the CCD 9. The scanner controller 21 is connected to the exposing lamp 3, a stepping motor 24, a HP (home position) sensor 25, and the open/close sensor 18. The stepping motor 24 drives the first scanning body 5 and the second scanning body 8. The home position sensor 25 detects whether the first scanning body 5 or the second scanning body 8 is at a predetermined home position.

Referring to FIG. 4, an exemplary structure of the image processor 20 is now explained. The image processor 20 includes an analog video processor 26, a shading corrector 27, and an image data processor 28. The analog video processor 26 performs amplification and digital conversion on the image data received from the CCD 9. The shading corrector 27 performs shading correction on the image data. The image data processor 28 performs image processing on the image data, including MTF correction, gamma correction and variable sizing, etc. The image data, which has been processed by the image processor 20, may be further processed by the main controller 19. Alternatively, the image data may be sent to the printer for image formation.

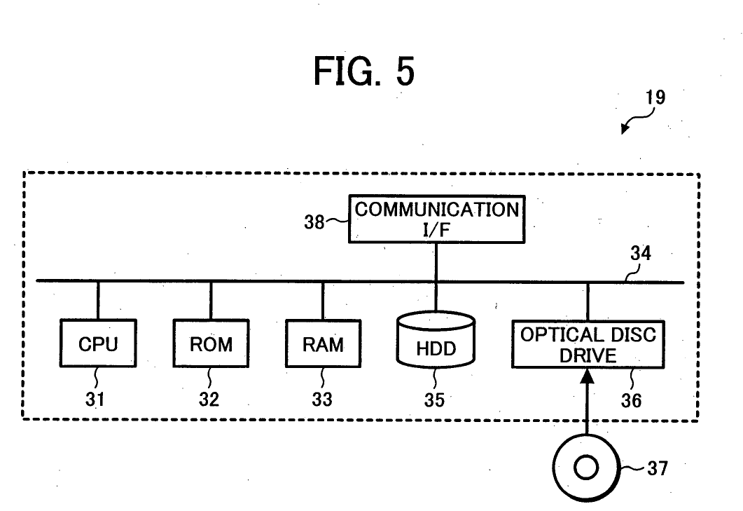

FIG. 5 illustrates an exemplary structure of the main controller 19. The main controller 19 includes a CPU (central processing unit) 31, a ROM (read only memory) 32, a RAM (random access memory) 33, a HDD (hard disk drive) 35, an optical disc drive 36, and a communication I/F (interface) 38, which are connected via a bus 34.

The CPU 31 controls the operation of the main controller 19. The ROM 32 stores BIOS (basic input output system), for example. The RAM 33 stores various data in an erasable manner to function as a work area of the CPU 31. The HDD 35 stores various programs to be operated by the CPU 31. The optical disc drive 36 reads data from an optical disc 37, for example. The optical disc 37 includes any kind of storage medium, such as CDs, DVDs, or magnetic disks, capable of storing various kinds of data. The communication I/F 38 allows the main controller 19 to communicate with other devices or apparatus.

In this exemplary embodiment, the CPU 31, the ROM 32, and the RAM 33 may together function as a microprocessor or any other kind of processor, capable of performing at least one of the operations disclosed below.

Further, in this exemplary embodiment, the HDD 35, the optical disc drive 36, and the communication I/F 38 may together function as a storage device storing a computer program, which allows the processor to perform at least one of the operations disclosed below. In one example, the CPU 31 may read the computer program stored in the optical disc 37 using the optical disc drive 36, and install it on the HDD 35. In another example, the CPU 31 may download the computer program from a network, such as the Internet, through the communication I/F 38, and install it on the HDD 35. Furthermore, the computer program may be operated on a predetermined operating system (OS), or may be included as a part in a group of files implementing an application software program such as a word processing program or the OS.

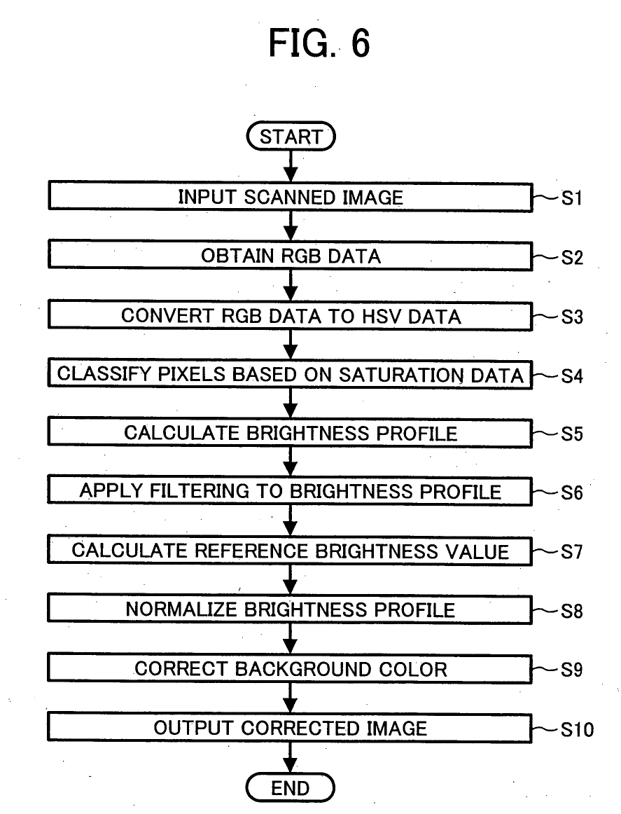

Referring now to FIG. 6, an operation of correcting background color of a scanned image, performed by the main controller 19, is explained according to an exemplary embodiment of the present invention.

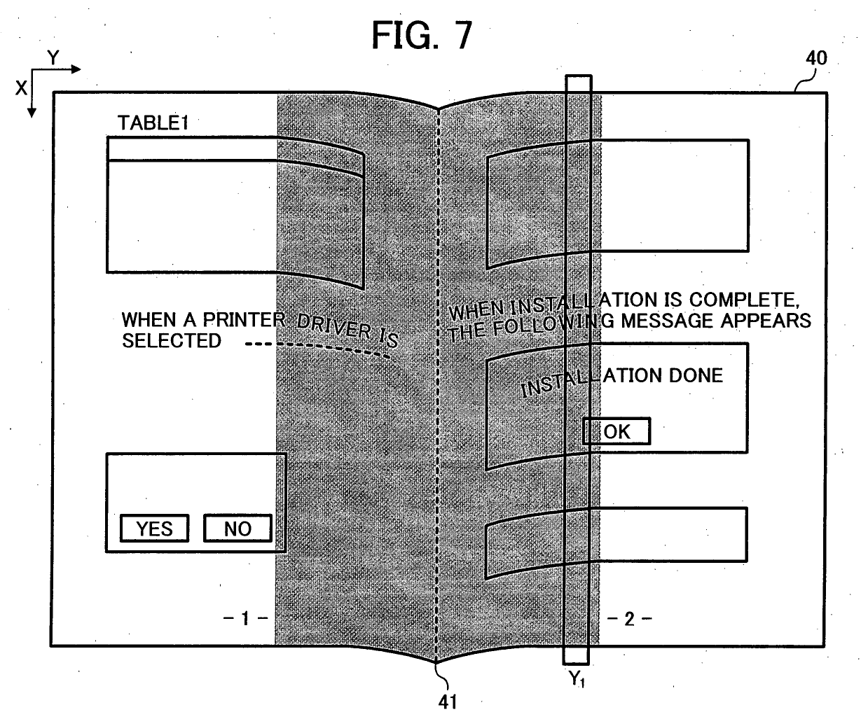

In the exemplary embodiments described below, a book document is placed on the exposure glass 2 such that its bound boundary 41 is made in parallel to the main scanning direction X of the scanner 1, as illustrated in FIG. 2. When the operational panel 22 receives an instruction for scanning or copying, for example, the CCD 9 generates image data of the corresponding pages of the book document. The image data is then provided to the image processor 20 for various image processing. In the exemplary embodiments described below, the image data received from the image processor 20 is referred to as a scanned image 40, as illustrated in FIG. 7. As shown in FIG. 7, the portion of the scanned image 40, corresponding to the bound boundary 41 of the book document, is assumed to have a background color darker than the background color of other portions. Further, the portion corresponding to the bound boundary 41 is also referred to as the boundary portion 41.

Referring back to FIG. 6, Step S1 inputs the scanned image 40.

Step S2 obtains color information of the scanned image 40, such as RGB (red, green, blue) data indicating R, G, and B values of each pixel included in the scanned image 40.

Step S3 converts the RGB data to HSV (hue, saturation, intensity value) or HSB (hue, saturation, brightness) data, using any one of the known color space conversion models. For simplicity, the intensity value and the brightness value are collectively referred to as the brightness value in the following disclosure.

For example, if a target pixel located in the coordinate (x, y) has the red value R(x, y), the green value G(x, y), and the blue value B(x, y), the brightness value V(x, y), the saturation value S(x, y), and the hue value H(x, y) for the target pixel may be calculated using the following equations:
V(x, y)=0.3*R(x, y)+0.59*G(x, y)+0.11*B(x, y);
H(x, y)=Tan⁻¹(R(x, y)−V(x, y))/(B(x, y)−V(x,y)); and
S(x, y)=√((R(x, y)−V(x, y))²+(B(x, y)−V(x, y))²).

Using the saturation value S(x, y) obtained in the previous step, Step S4 classifies the pixels in the scanned image 40 into a first group of pixels having high saturation values and a second group of pixels having low saturation values. In this exemplary embodiment, if a target pixel has a saturation value equal to or smaller than a reference saturation value, the target pixel is assumed to have an achromatic color. If a target pixel has a saturation value larger than the reference saturation value, the target pixel is assumed to have a chromatic color. The reference saturation value may be determined based on the empirical rule. Specifically, in this exemplary embodiment, the reference saturation value is set to 15%.

Step S5 calculates a brightness profile V(y) of the scanned image 40, which indicates the distribution of brightness values.

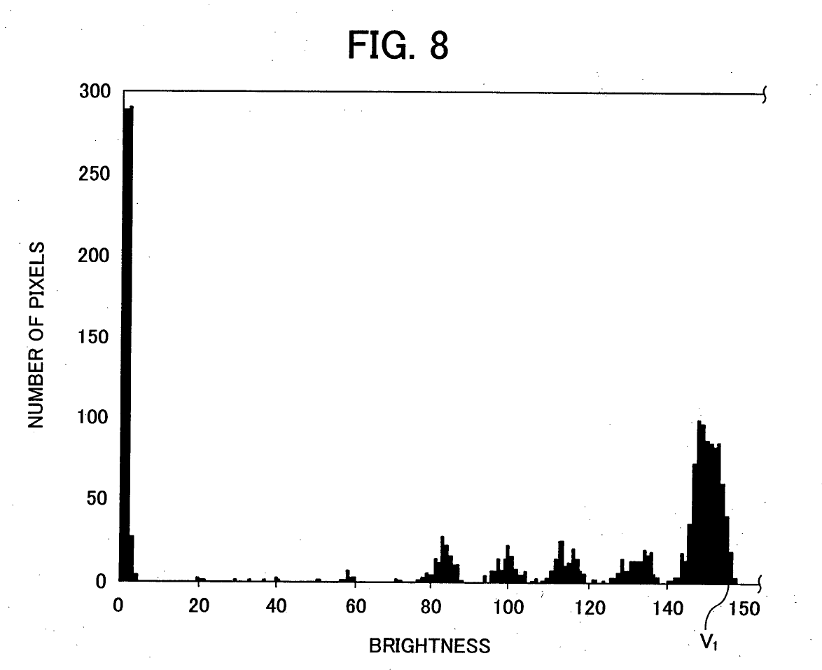

In one example, the scanned image 40 is sliced into a plurality of sections or lines (collectively referred to as the “section”), with each section having a longitudinal length in parallel to the boundary portion 41 or the main scanning direction X. For each of the sections, a histogram indicating the distribution of brightness values is generated, using the brightness values of the corresponding section. For example, FIG. 8 illustrates a histogram indicating the distribution of brightness values for a section Y1 of the scanned image 40 shown in FIG. 7.

Using the obtained histogram, such as the histogram shown in FIG. 8, the brightness values having a number of pixels larger than a predetermined number Vt are extracted. Preferably, in this exemplary embodiment, the predetermined number Vt is set to the number obtained by multiplying the number of pixels in the sub-scanning direction Y of the scanned image 40 with 0.1. Once the brightness values are extracted, the average of the extracted brightness values is obtained as the brightness profile V(y). In the exemplary case shown in FIG. 8, the brightness profile for the section Y1 is indicated as V1. This process is repeated for each of the sections of the scanned image 40.

Step S6, which is optionally provided, applies filtering to the brightness profile V(y) to remove noise data from the brightness profile V(y), using any one of the known filtering methods. For example, the brightness value of a target pixel may be replaced with the mean or median of brightness values of its neighboring pixels. This filtering process may be repeated for a few times or several times, if necessary.

Step S7 calculates a reference brightness value of the scanned image 40, using the brightness profile V(y) obtained in the previous step.

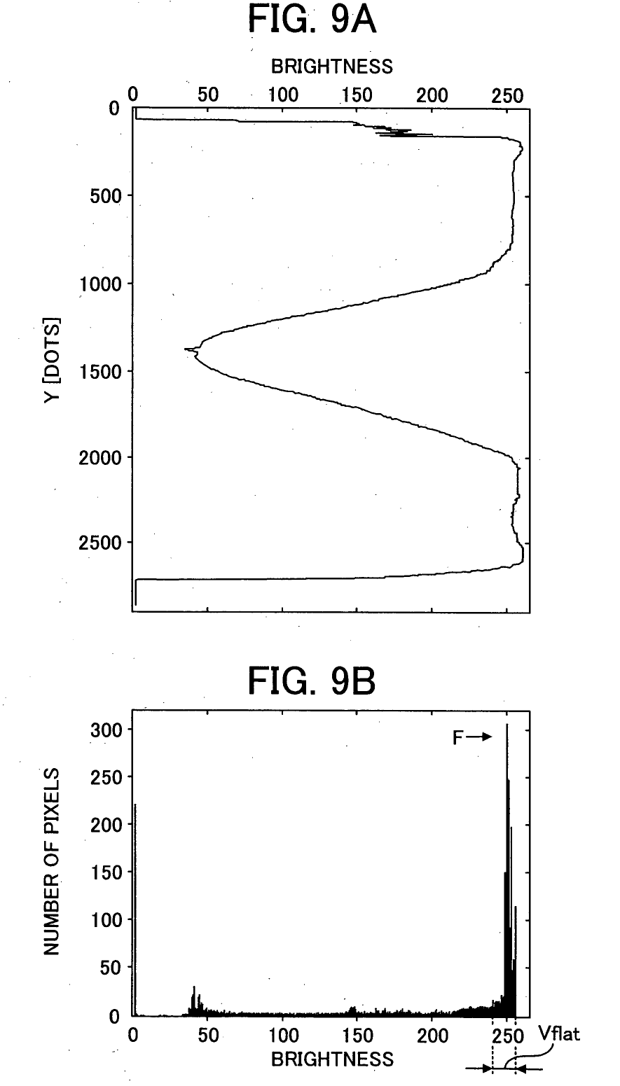

FIG. 9A is a graph illustrating the brightness profile V(y) for each of the sections of the scanned image 40. From the brightness profiles V(y) of FIG. 9A, the brightness value having the largest number of pixels (“the most frequent brightness value F”) can be extracted from the scanned image 40, as indicated by F in FIG. 9B. Based on the most frequent brightness value F, a reference brightness value Vflat is calculated, which can be used as a reference background color of the scanned image 40. For example, a range including the most frequent brightness value F may be set, for example, as the range between (F−Vm) and (F+Vm). The average of the brightness values belonging to that range is obtained as the reference brightness value Vflat, as illustrated in FIG. 9B. In this exemplary embodiment shown in FIG. 9B, the value Vm is set to 2.

Step S8 normalizes the brightness profile V(y) based on the reference brightness value Vflat. The normalized brightness profile Vn(y) may be obtained by dividing the brightness profile V(y) by the reference brightness value Vflat. The normalized brightness profile Vn(y) has a value ranging from 0 to 1. If a section of the scanned image 40 has a normalized brightness profile Vn(y) other than 1, preferably, closer to 0, that section is assumed to belong to a distorted portion of the scanned image 40. If a section of the scanned image 40 has a normalized brightness profile Vn(y) substantially equal to 1, that section is assumed to belong to an undistorted portion of the scanned image 40.

Step S9 corrects background color of the scanned image 40, using the normalized brightness profile Vn(y).

In this exemplary embodiment, this step first determines whether a target pixel has a chromatic color by referring to the group (defined in Step S4) to which the target pixel belongs. If the target pixel has a chromatic color, the saturation value S(x, y) and the brightness value V(x, y) of the target pixel are used for background color correction. For example, if the target pixel has the hue value H(x, y), the saturation value S(x, y), and the brightness value V(x, y), a corrected saturation value S′(x, y) and a corrected brightness value V′(x, y) are obtained, respectively, using the normalized brightness profile Vn(y) as follows: S′(x, y)=S(x, y)/Vn(y); and V′(x, y)=V(x, y)/Vn(y). The obtained HSV data, including the hue value H(x, y), the saturation value S′(x, y), and the brightness value V′(x, y), is converted to RGB data, using any one of the known color space conversion models.

If the target pixel has an achromatic color, only the brightness value V(x, y) of the target pixel is used for background color correction. For example, if the target pixel has the hue value H(x, y), the saturation value S(x, y), and the brightness value V(x, y), a corrected brightness value V′(x, y) is obtained using the normalized brightness profile Vn(y) as follows: V′(x, y)=V(x, y)/Vn(y). The obtained HSV data, including the hue value H(x, y), the saturation value S(x, y), and the brightness value V′(x, y), is converted to RGB data, using any one of the known color space conversion models.

Step S10 outputs the corrected image to any other device, such as the printer provided in the digital copier 16, the memory 23 provided in the digital copier 16, or the outside device via the communication I/F 38, for example. At this time, the main controller 19 may further perform distortion correction or blur correction on the corrected image.

In the operation illustrated in FIG. 6, the RGB data may be converted to data having any other kind of color space, including HLS (hue, luminance or lightness, saturation), for example, as long as the reference brightness value can be calculated.

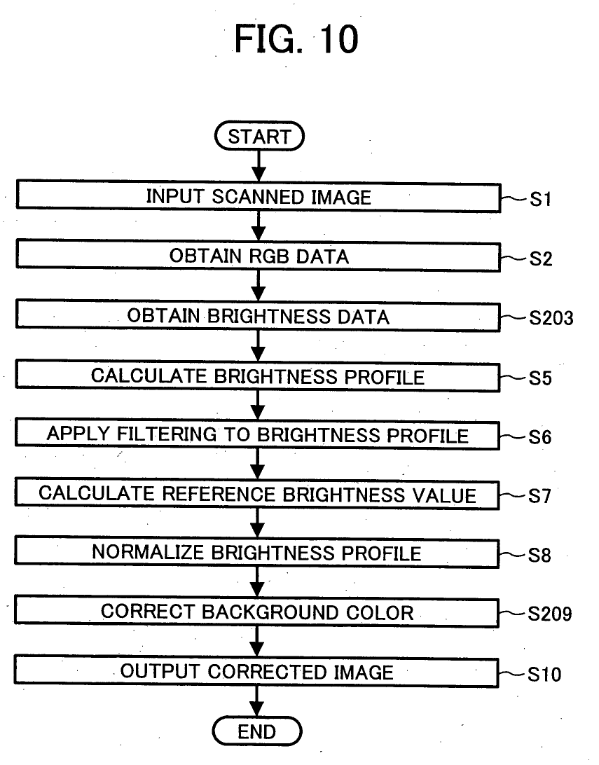

Referring now to FIG. 10, an exemplary operation of correcting background color of a scanned image, performed by the main controller 19, is explained according to another exemplary embodiment of the present invention.

The operation illustrated in FIG. 10 is substantially similar to the operation illustrated in FIG. 6. The differences include replacement of Step S3 with Step S203, deletion of Step S4, and replacement of Step S9 with Step S209.

Step S203 obtains a brightness value V(x, y) of each pixel in the scanned image 40 from the RGB data obtained in the previous step, using any one of the known color space conversion models. For example, the brightness value V(x, y) of a target pixel may be obtained through the equation: V(x, y)=0.3* R(x, y)+0.59*G(x, y)+0.11*B(x, y).

Step S209 corrects the background color of the scanned image 40, using the normalized brightness profile Vn(y). In this exemplary embodiment, the R value R(x, y), the G value G(x, y), and the B value B(x, y) of a target pixel are respectively corrected using the following equations: R′(x, y)=R(x, y)/Vn(y); G′(x, y)=G(x, y)/Vn(y); and B′(x, y)=B(x, y)/Vn(y).

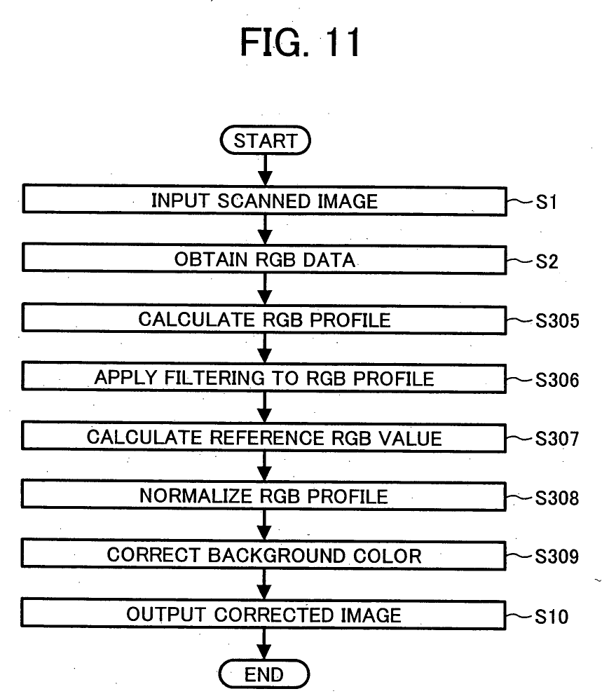

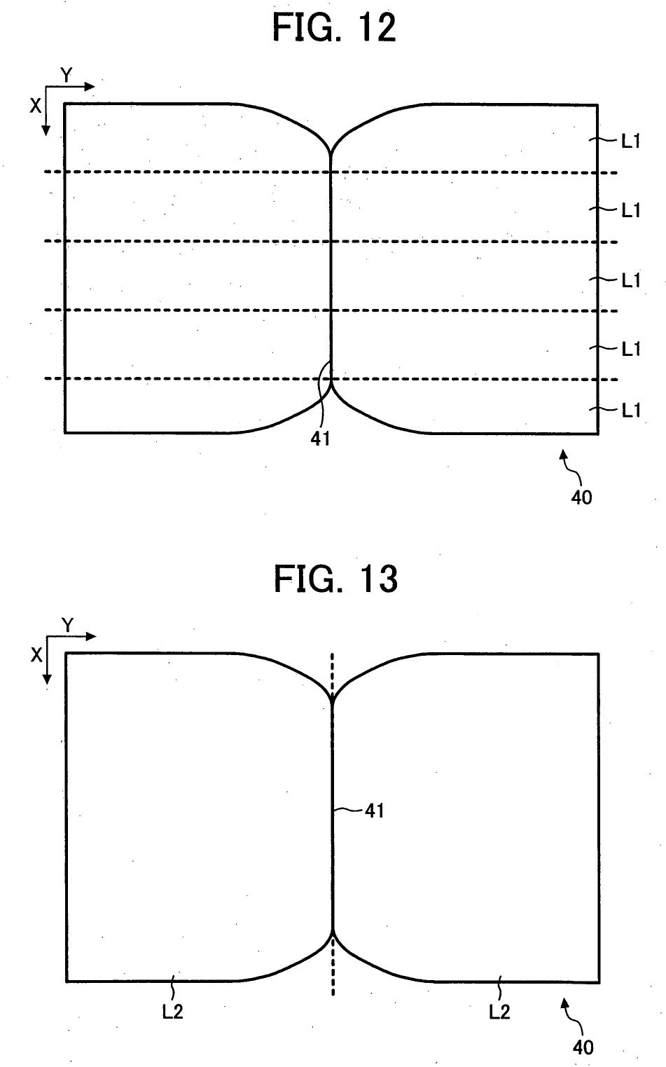

Referring now to FIG. 11, an exemplary operation of correcting the background color of a scanned image, performed by the main controller 19, is explained according to another exemplary embodiment of the present invention.

Step S1 inputs the scanned image 40.

Step S2 obtains color information of the scanned image 40, such as RGB data including R, G, and B values for each pixel included in the scanned image 40.

Step S305 calculates a profile of the scanned image 40, including a R profile, a G profile, and a B profile, using the RGB data obtained in the previous step.

In one example, a histogram showing the distribution of R values R(x, y) is generated for each section of the scanned image 40 in a substantially similar manner as described above with reference to Step S5. Similarly, a histogram showing the distribution of G values G(x, y), and a histogram showing the distribution of B values B(x, y) are generated, respectively.

Using the histogram for R values, the R values having a number of pixels larger than a predetermined number are extracted, and the average of the extracted R values is calculated as the R profile R(y). Similarly, the G profile G(y) of the scanned image 40 and the B profile B(y) of the scanned image 40 are obtained, respectively.

Step S306, which is optionally provided, applies filtering to the R profile R(y), the G profile G(y), and the B profile B(y), respectively, using any one of the known filtering methods.

Step S307 calculates a reference RGB value of the scanned image 40. In this exemplary embodiment, the R value having the largest number of pixels can be obtained from the histogram generated based on the R profile R(y). Using this R value, a reference R value Rflat is obtained, in a substantially similar manner as described above with reference to Step S7. Similarly, a reference G value Gflat and a reference B value Bflat can be obtained, respectively.

Step S308 normalizes the R profile R(y), the G profile G(y), and the B profile B(y), respectively, based on the corresponding R, G, and B reference values, in a substantially similar manner as described above with reference to Step S8. For example, the normalized R profile Rn(y) may be obtained by dividing the R profile R(y) by the reference R value Rflat. The normalized G profile Gn(y) may be obtained by dividing the G profile G(y) by the reference G value Gflat. The normalized B profile Bn(y) may be obtained by dividing the B profile B(y) by the reference B value Bflat. Each of the normalized profiles ranges from 0 to 1, with the value 1 corresponding to an undistorted portion of the scanned image 40.

Step S309 corrects background color of the scanned image 40, using the normalized R, G, and B profiles. For example, a corrected R value of a target pixel is obtained using the following equation: R′(x, y)=R(x, y)/Rn(y). Similarly, a corrected G value of the target pixel is obtained using the following equation: G′(x, y) G(x, y)/Gn(y). Similarly, a corrected B value of the target pixel is obtained using the following equation: B′(x, y)=B(x, y)/Bn(y).

Step S10 outputs the corrected image to any other device. At this time, the main controller 19 may further perform distortion correction or blur correction on the corrected image.

Any one of the above-described operations shown in FIGS. 6, 10 and 11 divides the scanned image into a plurality of sections, with each section having a longitudinal length parallel to the boundary portion 41 or the main scanning direction X. However, the scanned image may be divided into a plurality of sections, with each section having a longitudinal length perpendicular to the boundary portion 41 or the main scanning direction X. Further, any number of sections may be obtained.

In one example, as illustrated in FIG. 12, the scanned image 40 may be divided into a plurality of sections L1, with each section L1 having a longitudinal length perpendicular to the boundary portion 41 or the main scanning direction X. In this exemplary embodiment, the scanned image 40 is divided into five sections L1, however, the scanned image 40 may be divided into any number of sections L1. At this time, a page outline of the scanned image 40 may be extracted using the RGB data obtained from the scanned image. Example operations of page outline extraction are described, for example, in U.S. patent application Ser. No. 10/227,743, filed on Aug. 26, 2003, the U.S. patent application Ser. No. 11/054,396, filed on Feb. 10, 2005, and the U.S. Patent Application Publication No. 2003/0198398, published on Oct. 23, 2003.

In this exemplary embodiment, a color profile, such as a brightness profile or RGB profile, is calculated for each of the sections L1 based on pixel information included in the corresponding section L1, using any one of the above-described methods. At the same time, a reference background color, such as a reference brightness value or RGB value, of the scanned image 40 is calculated based on information obtained from the entire scanned image 40, using any one of the above-described methods. The background color in each of the sections L1 is corrected, using the color profile of the corresponding section L1 and the reference background color.

In another example, as illustrated in FIG. 13, the scanned image 40 may be divided into two sections L2, with each section L2 corresponding to one page of the scanned image 40. At this time, a page outline of the scanned image 40 may be extracted using the RGB data obtained from the scanned image.

In this exemplary embodiment, a color profile, such as a brightness profile or RGB profile, is calculated for each of the sections L2 based on pixel information included in the corresponding section L2, using any one of the above-described methods. At the same time, a reference background color of the scanned image 40, such as a reference brightness value or RGB value, is calculated based on information obtained from the entire scanned image 40, using any one of the above-described methods. The background color in each of the sections L2 is corrected, using the color profile of the corresponding section L2 and the reference background color.

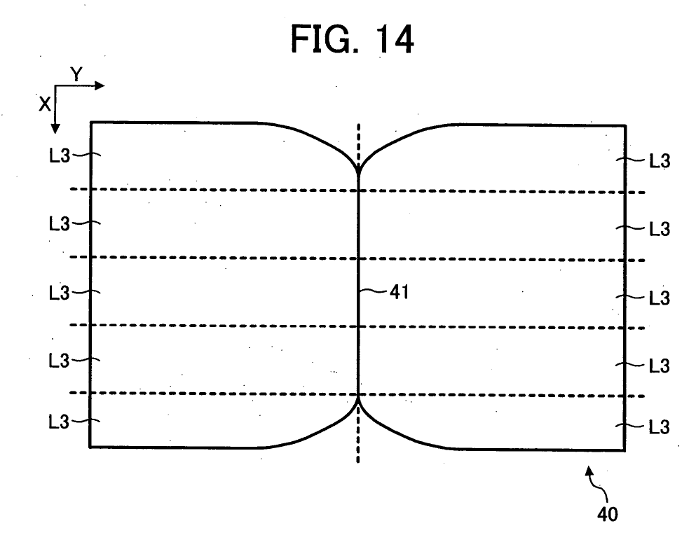

In another example, as illustrated in FIG. 14, the scanned image 40 may be divided into a plurality of sections L3 along with the main scanning direction X and the sub-scanning direction Y. In this exemplary embodiment, the scanned image 40 is divided into ten sections L3, however, the scanned image 40 may be divided into any number of sections L3, as long as it is equal to or larger than four. At this time, a page outline of the scanned image 40 may be extracted using the RGB data obtained from the scanned image 40.

In this exemplary embodiment, a color profile, such as a brightness profile or RGB profile, is calculated for each of the sections L3 based on pixel information included in the corresponding section L3, using any one of the above-described methods. At the same time, a reference background color of the scanned image 40, such as a reference brightness value or RGB value, is calculated based on information obtained from the entire scanned image 40, using any one of the above-described methods. The background color in each of the sections L3 is corrected, using the color profile of the corresponding section L3 and the reference background color.

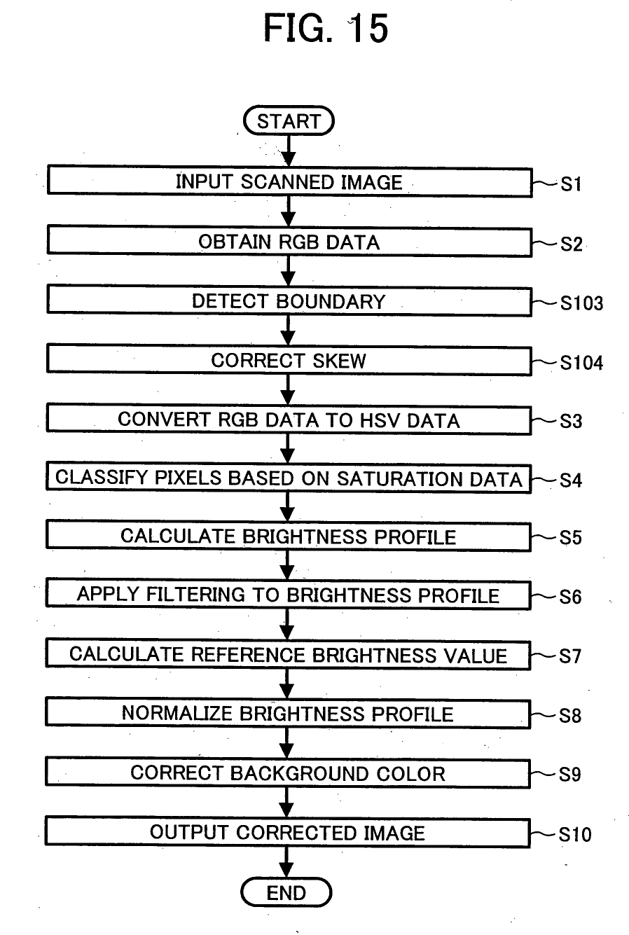

Referring now to FIG. 15, an operation for correcting the background color of a scanned image, performed by the main controller 19, is explained according to another exemplary embodiment of the present invention.

The operation shown in FIG. 15 is substantially similar to the operation shown in FIG. 6. The differences include the addition of Step S103 and Step S104.

Step S103 detects the location corresponding to the bound boundary 41 in the scanned image 40, using the RGB data obtained in the previous step. Exemplary operations of detecting the location corresponding to the bound boundary 41 are described, for example, in U.S. patent application Ser. No. 10/227,743, filed on Aug. 26, 2003, the U.S. patent application Ser. No. 11/054,396, filed on Feb. 10, 2005, and the U.S. Patent Application Publication No. 2003/0198398, published on Oct. 23, 2003.

Step S104 corrects skew of the scanned image 40, if the detected boundary portion 41 is not parallel to the main scanning direction X.

In the operation illustrated in FIG. 15, the RGB data may be converted to data having any other kind of color space, including HLS, for example.

Further, the RGB data may not be converted to the HSV data, as long as a reference brightness value can be calculated. If the RGB data is not converted to the HSV data and thus the saturation value cannot be obtained, the background color of the scanned image 40 is corrected without using the saturation value.

Numerous additional modifications and variations are possible in light of the above teachings. It is therefore to be understood that within the scope of the appended claims, the disclosure of this patent specification may be practiced otherwise than as specifically described herein.

For example, the scanned image 40 may not be a color image, as described in any one of the above operations. If the scanned image 40 is a grayscale image, an intensity value of each pixel is obtained as color information of the scanned image 40, which can be used to calculate a color profile or a reference background color.

Further, the placement of the book document is not limited to the above-described exemplary case shown in FIG. 2. For example, the book document may be placed such that the bound boundary 41 is made perpendicular to the main scanning direction X.

Furthermore, any one of the above-described and other operations performed by the main controller 109 may be performed by one or more conventional general purpose microprocessors and/or signal processors. Appropriate software coding can readily be prepared by skilled programmers based on the teachings of this disclosure or the appended claims.

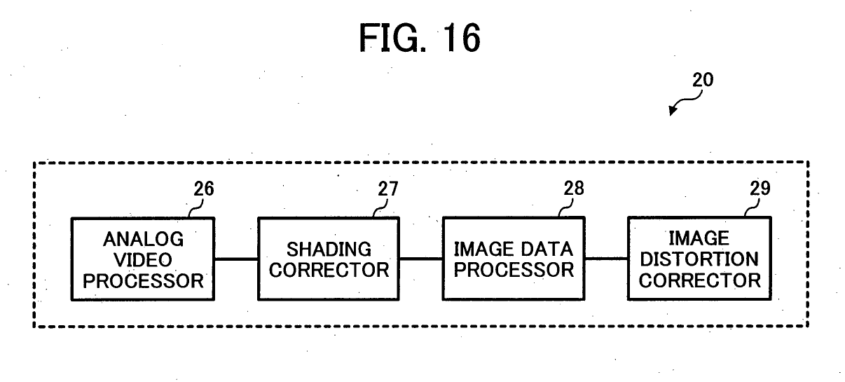

Alternatively, any one of the above-described and other operations performed by the main controller 109 may be performed by ASIC (Application Specific Integrated Circuits), prepared by interconnecting an appropriate network of conventional component circuits or by a combination thereof with one or more conventional general purpose microprocessors and/or signal processors programmed accordingly. For example, the image processor 20 of FIG. 3 may have a configuration show in FIG. 16. The image processor 20 of FIG. 16 additionally includes an image distortion corrector 29 capable of performing at least one of operations including correcting background color of a scanned image, correcting image distortion of a scanned image, and correcting blurring of a scanned image.

Furthermore, the scanner 1 may have a structure different from the structure described with reference to FIG. 1, as long as it is capable of correcting background color of a scanned image.

Furthermore, the background color correction function of the present invention may be performed by a device other than the scanner 1. In one example, the scanner 1 may be connected to any kind of general-purpose computer. The scanner 1 sends image data read from an original to the computer. The computer loads the program and operates at least one of the above-described and other methods according to the present invention. In another example, the computer may perform background color correction on image data, which has been stored in its storage device or received from the outside.

1. A method of correcting background color of a scanned image, comprising the steps of:
inputting a scanned image having a distorted portion and an undistorted portion;
extracting color information from the entire scanned image;
estimating a reference background color of the scanned image using the color information from the entire scanned image; and
correcting a background color of the scanned image using the reference background color.

2. The method of claim 1, wherein the reference background color corresponds to a background color of the undistorted portion.

3. The method of claim 1, further comprising the steps of:
dividing the scanned image into a plurality of sections; and
obtaining a color profile for each of the plurality of sections, with the reference background color being estimated based on the color profiles.

4. The method of claim 3, wherein the correcting step includes the steps of:
obtaining a normalized color profile for each of the plurality of sections; and
correcting the background color of each of the plurality of sections, using the corresponding one of the normalized color profiles.

5. The method of claim 1, further comprising the step of:
extracting saturation information from the entire scanned image, with the saturation information being used in the correcting step.

6. The method of claim 1, further comprising the step of:
detecting a bound boundary location of the scanned image.

7. The method of claim 6, further comprising the step of:
correcting skew of the scanned image.

8. A method of correcting image distortion, comprising the steps of:
inputting a scanned image having a distorted portion and an undistorted portion;
extracting color information from the entire scanned image;
estimating a reference background color of the scanned image using the color information from the entire scanned image;
correcting a background color of the scanned image using the reference background color;
extracting at least one of a page outline, a rule line, and a character line, from the scanned image; and
correcting distortion of the scanned image using at least one of the page outline, the rule line, and the character line.

9. The method of claim 8, further comprising the step of:
correcting blurring of the scanned image.

10. A background color correcting apparatus, comprising:
means for inputting a scanned image having a distorted portion and an undistorted portion;
means for extracting color information from the entire scanned image;
means for estimating a reference background color of the scanned image using the color information of the entire portion; and
means for correcting a background color of the scanned image using the reference background color.

11. The apparatus of claim 10, further comprising:
means for dividing the scanned image into a plurality of sections; and
means for obtaining a color profile for each of the plurality of sections, with the reference background color being estimated based on the color profiles.

12. The apparatus of claim 11, further comprising:
means for obtaining a normalized color profile for each of the plurality of sections.

13. The apparatus of claim 12, wherein the correcting means corrects a background color of each of the plurality of sections, using the corresponding one of the normalized color profiles.

14. The apparatus of claim 10, further comprising:
means for extracting saturation information from the entire scanned image, wherein the correcting means corrects the background color using the saturation information.

15. An image processing apparatus, comprising:
a processor; and
a storage device configured to store a plurality of instructions which, when activated by the processor, cause the processor to perform a correcting operation, including:
inputting a scanned image having a distorted portion and an undistorted portion;
extracting color information from the entire scanned image;
estimating a reference background color of the scanned image using the color information of the entire portion; and
correcting a background color of the scanned image using the reference background color.

16. The apparatus of claim 15, wherein the correcting operation further includes:
dividing the scanned image into a plurality of sections; and
obtaining a color profile for each of the plurality of sections, with the reference background color being estimated based on the color profiles.

17. The apparatus of claim 16, wherein the correcting operation further includes:
obtaining a normalized color profile for each of the plurality of sections, wherein a background color of each of the plurality of sections is corrected using the corresponding one of the normalized color profiles.

18. The apparatus of claim 15, wherein the correcting operation further includes:
correcting distortion of the distorted portion of the scanned image.

19. The apparatus of claim 18, wherein the correcting operation further includes:
outputting the corrected scanned image.

20. An image forming apparatus, comprising:
an input device configured to input a scanned image having a distortion portion caused by scanning; and
an image processor configured to estimate a reference background color of the scanned image using color information of the entire scanned image and to correct a background color of the distorted portion using the reference background color.

21. The apparatus of claim 20, wherein the image processor is configured to further correct distortion of the distorted portion.

22. The apparatus of claim 21, further comprising:
an output device configured to output the corrected scanned image.

23. A computer program, adapted to, when executed on a computer, cause the computer to carry out the steps of:
inputting a scanned image having a distorted portion and an undistorted portion;
extracting color information from the entire scanned image;
estimating a reference background color of the scanned image using the color information from the entire scanned image; and
correcting a background color of the scanned image using the reference background color.

24. The computer program of claim 23, wherein the program causes the computer to carry out the further steps of:
dividing the scanned image into a plurality of sections; and
obtaining a color profile for each of the plurality of sections, with the reference background color being estimated based on the color profiles.

25. The computer program of claim 24, wherein the program causes the computer to carry out the further steps of:
obtaining a normalized color profile for each of the plurality of sections; and
correcting the background color of each of the plurality of sections, using the corresponding one of the normalized color profiles.

26. The computer program of claim 23, wherein the program causes the computer to carry out the further step of:
extracting saturation information from the entire scanned image, with the saturation information being used in the correcting step.

27. A computer program product, comprising a computer program, adapted to, when executed on a computer, cause the computer to carry out the steps of:
inputting a scanned image having a distorted portion and an undistorted portion;
extracting color information from the entire scanned image;
estimating a reference background color of the scanned image using the color information from the entire scanned image; and
correcting a background color of the scanned image using the reference background color.

28. The computer program product of claim 27, wherein the program causes the computer to carry out the further steps of:
dividing the scanned image into a plurality of sections; and
obtaining a color profile for each of the plurality of sections, with the reference background color being estimated based on the color profiles.

29. The computer program product of claim 28, wherein the program causes the computer to carry out the further steps of:
obtaining a normalized color profile for each of the plurality of sections; and
correcting the background color of each of the plurality of sections, using the corresponding one of the normalized color profiles.

30. The computer program product of claim 27, wherein the program causes the computer to carry out the further step of:
extracting saturation information from the entire scanned image, with the saturation information being used in the correcting step.
